(19) United States
(12) Patent Application Publication
(10) Pub. No.: US 2023/0041635 A1
(43) Pub. Date: Feb. 9, 2023

(54) DRIVE UNIT AND DRIVE ASSEMBLY

(71) Applicant: Schaeffler Technologies AG & Co. KG, Herzogenaurach (DE)

(72) Inventor: Steffen Lehmann, Ettlingen (DE)

(73) Assignee: Schaeffler Technologies AG & Co. KG, Herzogenaurach (DE)

(21) Appl. No.: 17/782,177

(22) PCT Filed: Oct. 21, 2020
(86) PCT No.: PCT/DE2020/100907

§ 371 Date: Jun. 3, 2022

(30) Foreign Application Priority Data
Dec. 4, 2019 (DE) 10 2019 132 941.8

(51) Int. Cl. B60K 6/405; B60K 6/26; B60K 6/387; B60K 6/36; B60K 6/24; H02K 7/00; H02K 7/108; H02K 1/12; H02K 7/18

(52) U.S. Cl. CPC B60K 6/405; B60K 6/26; B60K 6/387; B60K 6/36; B60K 6/24; H02K 7/003; H02K 7/108; H02K 1/12; H02K 7/1815; B60K 2006/266

(57) ABSTRACT

A drive unit has a first electric rotary machine and a second electric rotary machine as well as a first shaft and a second shaft. A rotor of the first electric rotary machine is rotationally fixed to the first shaft, and a rotor of the second electric rotary machine is rotationally fixed to the second shaft. The drive unit additionally has a separating clutch. One of the two electric rotary machines is arranged at least partly radially and axially within an area radially delimited by the respective other electric rotary machine.

### CROSS-REFERENCE TO RELATED APPLICATIONS

This application is the U.S. National Phase of PCT Appln. No. PCT/DE2020/100907 filed Oct. 21, 2020, which claims priority to DE 102019132941.8 filed Dec. 4, 2019, the entire disclosures of which are incorporated by reference herein.

### TECHNICAL FIELD

The disclosure relates to a drive unit for a powertrain of an electrically drivable motor vehicle, in particular a hybrid motor vehicle, and to a drive assembly.

### BACKGROUND

Various drive units are known from the prior art, which are integrated in drive assemblies or powertrains.

DE 11 2015 006 071 T5 discloses a hybrid vehicle drive system with a generator that can generate electrical energy using the power of an internal combustion engine; an electric motor driven by electrical energy to drive wheels; a housing accommodating the generator and the electric motor, and a power control unit for controlling the generator and the electric motor. The generator and the electric motor are arranged side by side on the same axis within the housing.

WO 2019 101 264 A1 discloses a powertrain for a hybrid motor vehicle. The powertrain comprises a transmission input shaft which is operatively connected to a first electric machine and an internal combustion engine via a first sub-powertrain so as to transmit torque and which is operatively connected to a second electric machine via a second sub-powertrain so as to transmit torque. The two electric machines are arranged coaxially and axially adjacent to one another.

US 2016/0218584 A1 describes a control unit which is used to control electric machines, the control unit being mounted on a housing of the drive unit comprising the electric machines. In this case, the drive unit comprises two electric machines which are arranged coaxially and axially adjacent to one another.

### SUMMARY

Integrating a drive unit with several electric rotary machines in a drive assembly that is intended for a hybrid motor vehicle is subject to strict installation space requirements, particularly in the axial direction.

When using such a drive unit in so-called front-transverse assemblies in motor vehicles, in which the electric rotary machines and the internal combustion engine are used as front drives and a respective axis of rotation of an electric rotary machine and the internal combustion engine is arranged transversely to the longitudinal direction of the motor vehicle, a particularly short axial construction of the drive assembly is especially advantageous.

On this basis, the object of the present disclosure is to provide a drive unit and a drive assembly equipped therewith, by virtue of which an optimal operation can be ensured in an inexpensive and particularly space-saving manner.

The object is achieved by the drive unit according to the disclosure. Advantageous embodiments of the drive unit are described herein.

In addition, a drive assembly having the drive unit is provided according to disclosure.

The features of the claims may be combined in any technically useful way, including the explanations from the following description and features from the figures which comprise additional embodiments of the disclosure.

In the context of the present disclosure, the terms “axial” and “radial” always refer to the axis of rotation of the drive unit, which corresponds to the axis of rotation of at least one of the electric rotary machines comprised by the drive unit.

The disclosure relates to a drive unit for a powertrain of an electrically drivable motor vehicle, in particular a hybrid motor vehicle. The drive unit comprises a first electric rotary machine and a second electric rotary machine and a first shaft and a second shaft, wherein a rotor of the first electric rotary machine is connected in a rotationally fixed manner to the first shaft and a rotor of the second electric rotary machine is connected in a rotationally fixed manner to the second shaft. The drive unit also has a separating clutch with which a rotor of the first electric rotary machine is connectable or connected to the second shaft for the purpose of torque transmission. According to the disclosure, one of the two electric rotary machines is arranged at least partly radially and axially within an area that is radially delimited by the respective other electric rotary machine.

In one embodiment, it can be provided that the electric rotary machine arranged radially on the inside is arranged entirely radially and axially within a space that is radially delimited by the respective other electric rotary machine.

The separating clutch is arranged or in a torque transmission path running from the first electric rotary machine to the second shaft or is set up to open and close this torque transmission path. The drive unit can comprise an actuation system for actuating the separating clutch, wherein a release bearing of the actuation system can be designed in one or two rows.

Advantageously, the axes of rotation of the rotors of the electric rotary machines are positioned coaxially.

The radial nesting of the two electric rotary machines has the advantage that, during the production of the individual laminations of the rotor core and the stator core of both electric rotary machines, a lamination of the rotor of the radially inner electric rotary machine, of the stator of the radially inner electric rotary machine and also the stator of the radially outer electric rotary machine and the rotor of the radially outer electric rotary machine can all be cut out from a circuit board with a single punching stroke.

For the purpose of connecting it to the second shaft, the rotor of the radially outer electric rotary machine can be carried by a rotor carrier which is connected to the second shaft, wherein in particular the rotor is connected to the rotor carrier in a form-fitting and/or force-fitting manner and the rotor carrier is connected in a form-fitting and/or force-fitting manner to the second shaft.

For the purpose of rotatably mounting the first shaft and/or the second shaft, the drive unit can have a central bearing or a central bearing unit which is designed in one or more parts and by means of which the first shaft and/or the second shaft is mounted on a housing of the drive unit. The rotor carrier of the radially outer electric rotary machine can be mounted directly on the central bearing or indirectly on the second shaft on the central bearing. The central bearing is designed, for example, as a roller, ball or angular ball bearing.

The drive unit may include a fastening element which is bolted to one of the first or second shafts for securing the position of the rotor carrier of the radially outer electric rotary machine relative to the position of the second shaft.

Advantageously, the radially inner electric rotary machine can be operated as a generator. The rotor of the radially inner electric rotary machine is relatively small and thus has a lower mass moment of inertia than the rotor of the radially outer rotary machine.

Accordingly, the radially outer electric rotary machine can advantageously be used as a drive unit, since the rotor of this electric rotary machine is relatively large and can generate a correspondingly large torque.

This does not rule out the possibility that both the radially inner electric rotary machine and the radially outer electric rotary machine can be used for the purpose of driving a motor vehicle equipped with the drive unit. For example, the radially inner electric rotary machine can be used to conduct torque to an input side of the drive unit, so that an internal combustion engine that can be connected to the input side can be started. Alternatively, one or both electric rotary machines can also provide torque and, together with a connected internal combustion engine, implement a hybrid operation of the drive unit.

In one embodiment, the first electric rotary machine is arranged at least partly radially and axially within an area that is radially delimited by the second electric rotary machine.

The first electric rotary machine is designed as an internal rotor motor and the second electric rotary machine is designed as an external rotor motor, wherein the stator of the first electric rotary machine and the stator of the second electric rotary machine are mechanically fixed to one another.

Accordingly, one embodiment provides that the rotor of the first electric rotary machine is arranged within an area that is radially delimited by the stator of the second electric rotary machine.

According to an additional embodiment of the disclosure, the stators of the two electric rotary machines are arranged on a common stator carrier.

The stator carrier is in turn fixed to a housing of the drive unit.

In particular, this stator carrier can be arranged between the stators of the two electric rotary machines with regard to its radial position and can be mechanically connected to them, so that the stator carrier fixes both stators.

According to an alternative embodiment, the stators of the two electric rotary machines are integral components of a stator unit.

This stator unit can in turn be fixed to a housing of the drive unit. This alternative embodiment therefore does not use an extra stator carrier between the individual stators, but rather comprises a compact unit that is only formed from the two stators.

The fixing of the stator unit to a housing of the drive unit can be implemented using a number of screw connections. A respective screw of a screw connection is passed through the stator unit, in particular in the axial direction, and is screwed into a housing of the drive unit.

In one embodiment of the drive unit, it comprises a first housing and a second housing, which together define a housing interior in which the two electric rotary machines are arranged and in which the first shaft and the second shaft are at least partly arranged.

In particular, a common stator carrier or a stator unit is mechanically connected to the first housing, wherein the rotors of the two electric rotary machines are mounted on the second housing.

In particular, the second shaft can be mounted on the second housing, wherein it is possible for the first shaft to be mounted on the first housing and on the second shaft.

In addition, power electronics for controlling the electric rotary machines can be carried by the second housing.

In a structurally advantageous embodiment, the two shafts are arranged coaxially.

For this purpose, provision is made in particular for the second shaft to be designed as a hollow shaft and for the first shaft to run in sections within the second shaft.

According to a further embodiment, the drive unit has a first transmission stage, wherein the first transmission stage is formed by a connection element of the drive unit, comprising an internally toothed gear wheel, and the first shaft, having an element with an external toothing, wherein the toothing of the internally toothed gear wheel and the external toothing mesh with one other for the purpose of transmitting the rotational movement from the connection element to the first shaft.

Accordingly, the drive unit according to the disclosure is designed as a so-called hybrid transmission. This means that the drive unit also includes a transmission in addition to the electric rotary machines and the shafts.

In particular, the element with the external toothing can be a gear wheel arranged in a rotationally fixed manner on the first shaft.

In a further embodiment, the drive unit has a second transmission stage, which is formed by a toothing, in particular an external toothing, of the second shaft and a first gear wheel, meshing with the toothing of the second shaft.

In one embodiment, in which the drive unit has a transmission, the first gear wheel can be coupled in a rotationally fixed manner to an intermediate shaft of the transmission.

This transmission can include a differential transmission in the output region. An external toothing of the intermediate shaft can mesh with an input gear wheel of the differential transmission, as a result of which a third transmission stage is realized.

The second shaft thus functions here as a transmission input shaft and is operatively connected to the transmission, so that a torque provided by the second shaft or the rotational movement realized by the second shaft can be transmitted via the transmission to another transmission unit of a motor vehicle in a stepped-up or stepped-down manner, or can be routed directly to the drive wheels of a motor vehicle.

The drive unit according to the disclosure has the advantage that due to the axial nesting of the electric rotary machines, significantly less axial installation space is required than in conventional drive units with two electric rotary machines.

In addition, according to the disclosure, a drive assembly is provided, having a drive unit according to the disclosure and an internal combustion engine, wherein an output element of the internal combustion engine is or can be coupled in a rotationally fixed manner to the rotor of the first electric rotary machine.

When operating a motor vehicle, in particular a hybrid vehicle, with a drive assembly according to the disclosure, comprising a drive unit according to the disclosure and an internal combustion engine, the following driving operating modes are enabled, for example:

Electric Driving and Recuperation:

The separating clutch is open, as a result of which the second electric rotary machine is decoupled from the first electric rotary machine and the internal combustion engine. The second electric rotary machine is thus controlled separately as a traction machine or as a generator. The internal combustion engine and the first electric rotary machine are not in operation.

Serial Driving and Charging:

The separating clutch is open. The internal combustion engine is started by means of the first electric rotary machine, wherein the internal combustion engine can drive the first electric rotary machine and, consequently, the first electric rotary machine is controlled as a generator in order to charge the battery of the motor vehicle. The second electric rotary machine is controlled as a traction machine.

Parallel Hybrid Drive, Charging, and Boosting:

The separating clutch is closed, as a result of which the first electric rotary machine, the second electric rotary machine, and the internal combustion engine are coupled to one another. The motor vehicle is driven by means of the internal combustion engine and/or one or both electric rotary machines. The two electric rotary machines can be controlled here as a traction machine or as a generator.

In a further embodiment, the drive assembly also comprises at least one wheel drive shaft, on which wheels of a motor vehicle equipped with the drive assembly are to be arranged, and which is connected to the second shaft of the drive unit via the transmission of the drive unit, so that a rotational movement realized by the second shaft can be transferred to the wheel drive shaft and thus to the wheels via the transmission.

According to one embodiment of the drive assembly, the drive assembly comprises a vibration damper connected in a rotationally fixed manner to the connection element of the drive unit and a housing element mechanically connected to the internal combustion engine, wherein the vibration damper is arranged in the housing element.

The housing element is advantageously connected to the second housing of the drive unit.

A pump actuator of a cooling circuit of the drive unit can be mounted in the housing element.

It can further be provided that the intermediate shaft and/or the wheel drive shaft are mounted axially in the housing element and mounted in the second housing.

### BRIEF DESCRIPTION OF THE DRAWINGS

The disclosure described above is explained in detail below based on the relevant technical background with reference to the associated drawings, which show preferred embodiments. The disclosure is in no way restricted by the purely schematic drawings, although it should be noted that the embodiments shown in the drawings are not limited to the dimensions shown. In the drawings:

FIG. 1: shows a schematic representation of a drive assembly according to the disclosure with a drive unit according to the disclosure,

FIG. 2: shows a section of the drive assembly according to the disclosure in a sectioned side view,

FIG. 3: shows a section of the drive unit according to the disclosure in the region of the electric rotary machines and

FIG. 4 shows a section of a drive unit according to the disclosure in the region of the electric rotary machines in an alternative embodiment.

### DETAILED DESCRIPTION

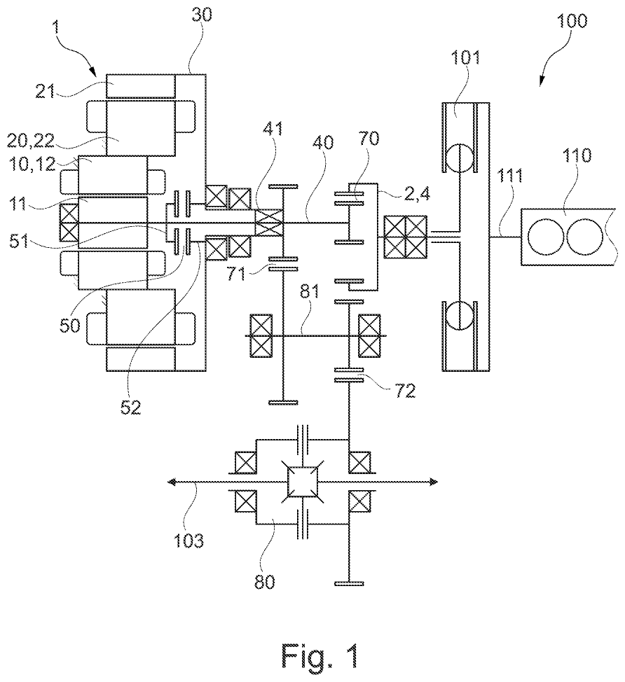

FIG. 1 shows a schematic representation of a drive assembly 100 according to the disclosure with a drive unit 1 according to the disclosure.

The drive unit 1 comprises a first electric rotary machine 10, a second electric rotary machine 20, a first shaft 40 and a second shaft 41.

Furthermore, the drive assembly 100 comprises an internal combustion engine 110 and a vibration damper 101, wherein an output element 111 of the internal combustion engine 110 is coupled to the vibration damper 101. The vibration damper 101 is also connected to a connection element 4 of the drive assembly 1 which acts as an input side 2 of the drive assembly 1. The internal combustion engine 110 is coupled to the drive assembly 1 via a vibration damper 110.

The connection element 4 is coupled to the first shaft 40 in such a way that a first transmission stage 70 is formed between the connection element 4 and the first shaft 40.

A rotor 11 of the first electric rotary machine 10 is connected to the first shaft 40 in a rotationally fixed manner and a rotor 21 of the second electric rotary machine 20 is connected to the second shaft 41 in a rotationally fixed manner. The rotor 11 of the first electric rotary machine 10 is connected to the first shaft 40 in such a way that the rotor 11 of the first electric rotary machine 10 is arranged directly on the first shaft 40. In contrast, the rotor 21 of the second electric rotary machine 20 is carried by a rotor carrier 30 and the rotor carrier 30 is connected to the second shaft 41.

The first electric rotary machine 10 is arranged radially and partly axially within an area that is delimited radially by the second electric rotary machine 20. The first electric rotary machine 10 is designed as an internal rotor motor and the second electric rotary machine 20 is designed as an external rotor motor, wherein a stator 12 of the first electric rotary machine 10 and a stator 22 of the second electric rotary machine 20 are mechanically fixed to one another.

A separating clutch 50 of the drive unit 1 is connected to the first shaft 40 by its input side 51 and to the second shaft 41 by its output side 52. The separating clutch 50 thus serves to transmit torque between the first shaft 40 and the second shaft 41. Correspondingly, a torque transmission path between the rotor 11 of the first electric rotary machine 10 and the rotor 21 of the second electric rotary machine 20 can be opened or closed by means of the separating clutch 50.

The second shaft 41 is designed as a hollow shaft and the first shaft 40 runs partly radially within the second shaft 41. The two shafts 40, 41 thus run coaxially to one another, wherein the rotors 11, 21 of the two electric rotary machines 10, 20 are also arranged coaxially to one another and coaxially to the shafts 40, 41.

The second shaft 41 is connected to an intermediate shaft 81 via a second transmission stage 71. The intermediate shaft 81 runs parallel to the second shaft 41.

The intermediate shaft 81 is connected via a third transmission stage 72 to an input element of a differential transmission 80 of the drive unit 1 for the purpose of transmitting torque. The differential transmission 80 forms an output side 3 of the drive unit 1.

A wheel drive shaft 103, on which wheels of a motor vehicle equipped with the drive assembly 100 are to be arranged, forms the output of differential transmission 80, so that a rotational movement realized by second shaft 41 can be transmitted to the wheel drive shaft 103 and thus to the wheels via the second transmission stage 71 and the third transmission stage 72 and via the differential transmission 80.

A torque provided by internal combustion engine 110 is transmitted to the first shaft 40 of the drive unit 1 via the vibration damper 101 and via first transmission stage 70. If the separating clutch 50 is opened, the torque of the internal combustion engine 110 is only conducted to the rotor 11 of the first electric rotary machine 10. In this way, the first electric rotary machine 10 can be used in a generator operation to charge a battery. If the separating clutch 50 is closed, the torque provided by the internal combustion engine 110 is transmitted from the first shaft 40 to the second shaft 41. The torque of the internal combustion engine 110 is conducted from the second shaft 41 to the intermediate shaft 81 via the second transmission stage 71 and to the differential transmission 80 via the third transmission stage 72. The torque reaches the wheels of a motor vehicle equipped with the drive assembly 100 by means of the wheel drive shaft 103 via the differential transmission 80.

A torque provided by the rotor 11 of the first electric rotary machine 10 can be transmitted to the internal combustion engine 110 via the first transmission stage 70 when the separating clutch 50 is opened. When the separating clutch 50 is closed, it is transmitted via the second transmission stage 71 and the third transmission stage 72 to the differential transmission 80 and thus to the wheel drive shaft 103.

A torque provided by the rotor 21 of the second electric rotary machine 20 is transmitted independently of a shifting of the separating clutch 50 via the second transmission stage 71 and the third transmission stage 72 to the differential transmission 80 and thus to the wheel drive shaft 103.

Accordingly, the drive assembly 100 can be operated in a plurality of driving operating modes.

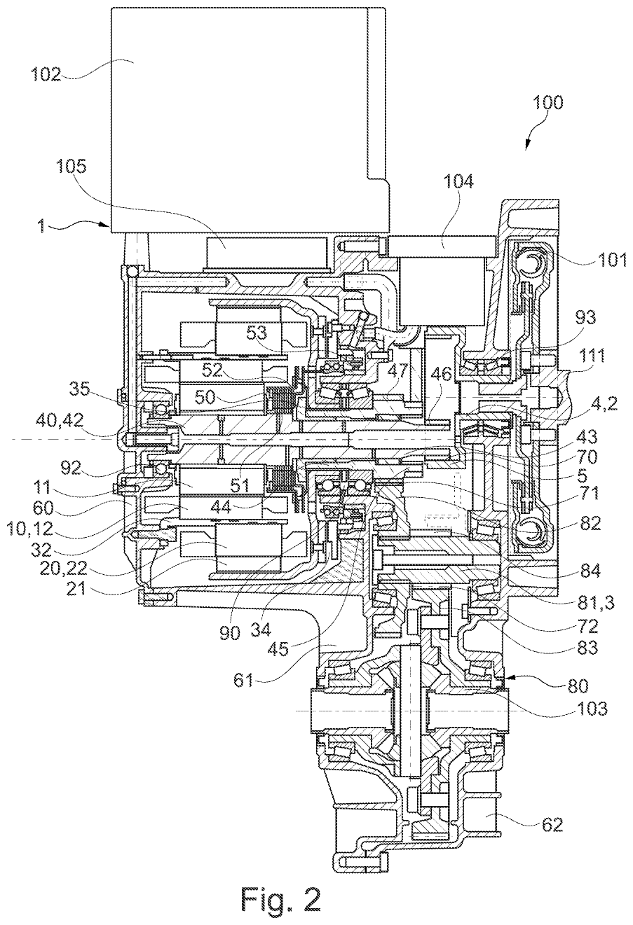

FIG. 2 shows a section of the drive assembly 100 according to the disclosure in a sectional side view.

FIG. 2 is a more detailed illustration of the individual components indicated in FIG. 1, wherein the internal combustion engine is not shown in FIG. 2 and the output element 111 of the internal combustion engine coupled to the vibration damper 101 is only partially shown.

A first housing 60, a second housing 61 and a housing element 62 can be seen in FIG. 2, which are connected to one another and form the entire housing of the drive assembly 100 or the drive unit 1. The first and second housings 60, 61 serve to accommodate the two electric rotary machines 10, 20, with the housing element 62 serving to couple the first housing 60 and the second housing 61 to a housing of the internal combustion engine (not shown). For this purpose, the first housing 60 is firmly connected to the second housing 61 in the axial direction, with the housing element 62 being firmly connected to the second housing 61 on the side of the second housing 61 axially opposite the first housing 60.

The first shaft 40 is mounted in the first housing 60 with its first axial end area 42 via a single-row support bearing 92 and is mounted radially inside on a second axial end area 45 of the second shaft 41 with its second axial end area 43 via a needle bearing 91.

The second shaft 41 is mounted on the second housing 61 with its first axial end area 44 via a central bearing unit 90. This central bearing unit 90 comprises two coaxially arranged roller bearings which are positioned axially close together.

Furthermore, a common stator carrier 32 carrying the stators 12, 22 of the electric rotary machines 10, 20 is firmly connected to the first housing 60, so that the stators 12, 22 of the electric rotary machines 10, 20 are carried by the first housing 60. The rotor carrier 30 of the rotor 21 of the second electric rotary machine 20 is mounted on the second housing 61 by means of a roller bearing of the central bearing unit 90. A transmitter element of a rotor position sensor 34 is also connected to a rotor carrier 30, wherein a detector element of the rotor position sensor 34 is connected to the second housing 61, so that an angular position and/or a rotational speed of the rotor 21 of the second electric rotary machine 20 or of the rotor carrier can be detected 30 by the rotor position sensor 34.

In addition, the intermediate shaft 81 and the wheel drive shaft 103 are each mounted in the second housing 61 on their axial side facing the electric rotary machines 10, 20 and mounted in the housing element 62 on their opposite axial side. The connection element 4 of the drive unit 1 is mounted on the housing element 62 via a double row bearing unit 93. This double row bearing unit 93 comprises two coaxially arranged roller bearings which are positioned axially close together. The vibration damper 101 is arranged in the housing element 62.

The central bearing unit 90 and the double row bearing unit 93 are each shown in different possible embodiments to clarify their possible configurations. The central bearing unit 90 is shown with tapered roller bearings and with angular ball bearings, while the double row bearing unit 93 is shown with tapered roller bearings. However, as mentioned regarding the central bearing unit 90, other bearings can also be used here, such as angular ball bearings.

Furthermore, power electronics 102 are arranged radially on the outside on the first and second housing 60, 61, wherein the power electronics 102 are set up to control the electric rotary machines 10, 20. In addition, a heat exchanger 105 of a cooling circuit for cooling at least one of the electric rotary machines 10, 20 on the second housing 61 is also arranged between the second housing 61 and the power electronics 102. A pump actuator 104 of this cooling circuit is carried by the housing element 62.

FIG. 2 also shows a detailed structure of the transmission stages 70, 71, 72.

The first transmission stage 70 is designed in such a way that the connection element 4 comprises an internally toothed gear wheel 5 which meshes with an external toothing 46 on the second axial end region 43 of the first shaft 40.

The second shaft 41 also has an external toothing 47 on its second axial end region 45, with which it meshes with a first gear wheel 82, wherein the first gear wheel 82 is arranged on the intermediate shaft 81 in a rotationally fixed manner, so that the second transmission stage 71 is formed between the second shaft 41 and the intermediate shaft 81.

An external toothing 84 of the intermediate shaft 81 meshes with a second gear wheel 83 as an input element of the differential transmission 80, as a result of which the third transmission stage 72 is formed between the intermediate shaft 81 and the differential transmission 80.

The separating clutch 50 corresponds to a friction-fitting multi-plate clutch, the input side 51 of which is formed by inner discs, which are arranged axially next to the rotor 11 of the first electric rotary machine 10 on the first shaft 40, wherein the outer disks of the separating clutch 50 are connected to the second shaft 41 as its output side 52.

An actuating system 53 for actuating the separating clutch 50 is arranged on the second housing 61 radially outside of the central bearing unit 90, wherein a pressure pad of the actuating system 53 extends axially through the rotor carrier 30 in order to transfer an actuating force provided by the actuating system 53 to the separating clutch 50 in order to close it.

A securing screw 35 is also provided, which is screwed into the first axial end region 44 of the second shaft 41, so that a screw head of the securing screw 35 exerts an axial pretensioning force on the rotor carrier 30 and the two roller bearings of the central bearing unit 90, as a result of which the axial position of the rotor carrier 30 and the central bearing unit 90 in relation to the second shaft 41 is secured.

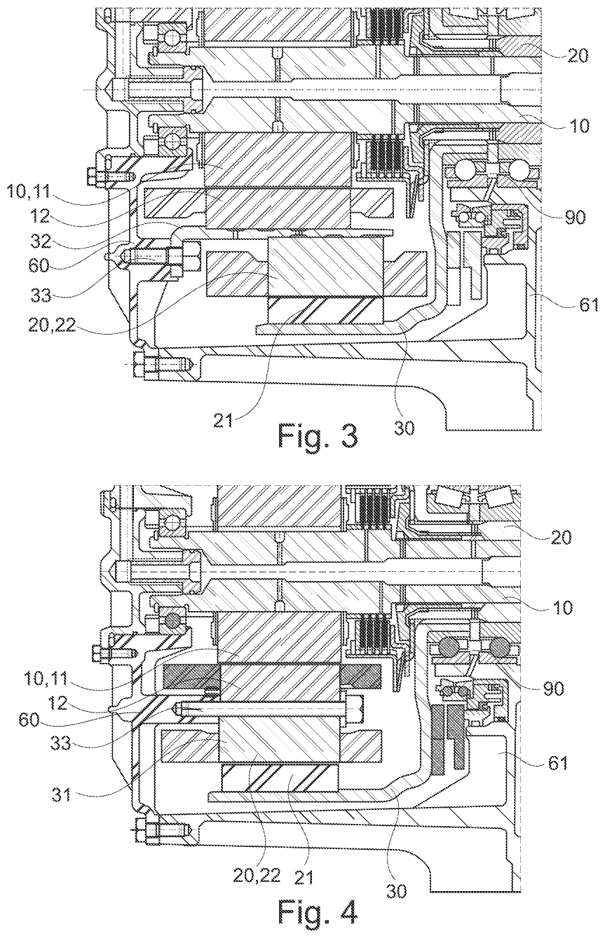

FIG. 3 shows a section of a drive unit 1 according to the disclosure in the region of the electric rotary machines 10, 20.

The section shows a drive unit 1, identical to the embodiment of the drive unit 1 from FIG. 2.

It can be seen in FIG. 3 that the common stator carrier 32 is connected to the first housing 60 by means of a carrier screw 33. For this purpose, the carrier screw 33 is guided axially through a radially running section of the common stator carrier 32 and screwed in the axial direction into the first housing 60.

In addition, the stator 12 of the first electric rotary machine 10, which is carried on the radial inner side of the common stator support 32, is axially offset to the stator 22 of the second electric rotary machine 20, which is carried on the radial outer side of the common stator carrier 32.

As an alternative to the drive unit 1 from FIG. 3, FIG. 4 shows a section of a drive unit 1 according to the disclosure in the region of the electric rotary machines 10, 20 in an alternative embodiment.

The difference here from FIG. 3 is that the stators 12, 22 of the two electric rotary machines 10, 20 are integral components of a stator unit 31.

This stator unit 31 is fixed to the first housing 60 by a carrier screw 33 which is passed through the entire stator unit 31 in the axial direction and is screwed into the first housing 60 in the axial direction. This alternative embodiment therefore does not use an extra stator carrier between the individual stators 12, 22, but rather comprises a compact unit that is only formed from the two stators 12, 22.

By virtue of the drive unit and the drive assembly according to the disclosure, an optimal operation can be ensured in an inexpensive and particularly space-saving manner.

### LIST OF REFERENCE NUMBERS

1 Drive unit
2 Input side of the drive unit
3 Output side of the drive unit
4 Connection element of the drive unit
5 Internally toothed gear wheel of the connection element
10 First electric rotary machine
11 Rotor of the first electric rotary machine
12 Stator of the first electric rotary machine
20 Second electric rotary machine
21 Rotor of the second electric rotary machine
22 Stator of the second electric rotary machine
30 Rotor carrier of the second electric rotary machine
31 Stator unit
32 Common stator carrier
33 Carrier screw
34 Rotor position sensor
35 Securing screw
40 First shaft
41 Second shaft
42 First axial end region of the first shaft
43 Second axial end region of the first shaft
44 First axial end region of the second shaft
45 Second axial end region of the second shaft
46 External toothing of the first shaft
47 External toothing of the second shaft
50 Separating clutch
51 Input side of the separating clutch
52 Output side of the separating clutch
53 Actuation system
60 First housing
61 Second housing
62 Housing element
70 First transmission stage
71 Second transmission stage
72 Third transmission stage
80 Differential transmission
81 Intermediate shaft
82 First gear wheel
83 Second gear wheel
84 External toothing of the intermediate shaft
90 Central bearing unit
91 Needle bearing
92 Support bearing
93 Double row bearing unit
100 Drive assembly
101 Vibration damper
102 Power electronics
103 Wheel drive shaft
104 Pump actuator
105 Heat exchanger
110 Internal combustion engine
111 Output element of the internal combustion engine

1. A drive unit for a powertrain of an electrically drivable motor vehicle, comprising: a first electric rotary machine and a second electric rotary machine as well as a first shaft and a second shaft, wherein a rotor of the first electric rotary machine is rotationally fixed to the first shaft, and a rotor of the second electric rotary machine is rotationally fixed to the second shaft and wherein the drive unit additionally has a separating clutch, with which the rotor of the first electric rotary machine is connectable to the second shaft for torque transmission, wherein one of the first or second electric rotary machines is arranged at least partly radially and axially within an area radially delimited by the respective other electric rotary machine.

2. The drive unit according to claim 1, wherein the first electric rotary machine is arranged at least partly radially and axially within an area radially delimited by the second electric rotary machine.

3. The drive unit according to claim 2, wherein the first electric rotary machine is designed as an internal rotor motor and the second electric rotary machine is designed as an external rotor motor, wherein a stator of the first electric rotary machine and a stator of the second electric rotary machine are mechanically fixed to one another.

4. The drive unit according to claim 3, wherein the stators of the first and second electric rotary machines are arranges on a common stator carrier.

5. The drive unit according to claim 3, wherein the stators of the first and second electric rotary machines are integral components of a stator unit.

6. The drive unit according to claim 1, wherein the first and second shafts are arranged coaxially.

7. The drive unit according to claim 1, wherein the drive unit has a first transmission stage, wherein the first transmission stage is formed by a connection element, comprising an internally toothed gear wheel, and the first shaft, having an element with an external toothing, wherein the toothing of the internally toothed gear wheel and the external toothing mesh with one other for transmitting a rotational movement from the connection element to the first shaft.

8. The drive unit according to claim 7, further comprising: a second transmission stage, which is formed by a toothing of the second shaft and a first gear wheel, meshing with the toothing of the second shaft.

9. A drive assembly having a drive unit according to claim 7 and an internal combustion engine, which is coupled in a rotationally fixed manner to the rotor of the first electric rotary machine by an output element of the internal combustion engine.

10. The drive assembly according to claim 9, wherein the drive assembly comprises a vibration damper connected in a rotationally fixed manner to the connection element of the drive unit and a housing element mechanically connected to the internal combustion engine, wherein the vibration damper is arranged in the housing element.

11. A drive unit for a powertrain of an electrically drivable motor vehicle, comprising:
a housing;
a first electric rotary machine having a first rotor and a first stator;
a second electric rotary machine having a second rotor and a second stator, wherein the first rotor is rotationally fixed to a first shaft and the second rotor is rotationally fixed to a second shaft;
a separating clutch configured to selectively connect the first rotor of the first electric rotary machine to the second shaft for torque transmission, wherein the first electric rotary machine is arranged at least partly radially and axially within an area radially delimited by the second electric rotary machine; and
a stator carrier fixed to the housing, wherein the first stator is fixed to a radial inner side of the stator carrier and the second stator is fixed to a radial outer side of the stator carrier.

12. The drive unit according to claim 11, wherein the housing includes a first housing and a second housing, wherein the stator carrier is fixed to the first housing.

13. The drive unit according to claim 12, wherein first rotor is arranged directly on the first shaft and the second rotor is mounted on a rotor carrier connected to the second shaft, wherein the rotor carrier is mounted on the second housing.
